(19) United States
(12) Patent Application Publication
(10) Pub. No.: US 2015/0137419 A1
(43) Pub. Date: May 21, 2015

(54) BONDING METHOD AND APPARATUS

(71) Applicant: Durr Systems GmbH, Bietigheim-Bissingen (DE)

(72) Inventors: Marc Ullmann, Stuttgart (DE); Lothar Rademacher, Bietigheim-Bissingen (DE)

(73) Assignee: Durr Systems GmbH, Bietigheim-Bissingen (DE)

(21) Appl. No.: 14/406,540

(22) PCT Filed: Jun. 7, 2013
(86) PCT No.: PCT/EP2013/001683

§ 371 Date: Dec. 9, 2014

(30) Foreign Application Priority Data
Jun. 20, 2012 (DE) 10 2012 012 298.5

(51) Int. Cl. B29C 65/54; F03D 1/06

(52) U.S. Cl. CPC B29C 65/542; F03D 1/0675
USPC 264/261; 425/129.1

(57) ABSTRACT

Assembly parts are bonded together, the parts having adhesive surfaces on end surfaces thereof to be joined together, e.g., for bonding together rotor blade half shells to form a rotor blade for a wind turbine. The assembly parts can be bonded together by injection-bonding, an adhesive being injected into an adhesive joint between the adhesive surfaces of the assembly parts.

### CROSS-REFERENCE TO RELATED APPLICATIONS

This application is a National Phase of, and claims priority to, International Application No. PCT/EP2013/001683 filed on Jun. 7, 2013, which claims priority to German Application No. DE 10 2012 012 298.5 filed on Jun. 20, 2012, each of which applications are hereby incorporated by reference in their entireties.

### BACKGROUND

During manufacture of rotor blades for wind turbines, two rotor blade half shells are bonded together, wherein a number of work steps are required during the bonding process. Firstly, the adhesive surfaces on the rotor blade half shells must be prepared in order to achieve a good bonding result. The adhesive is then applied to the adhesive surfaces of the two rotor blade half shells. Finally, the rotor blade half shells are then joined together and held in place until the adhesive has cured enough to create sufficient handling strength. This known bonding method for rotor blade half shells has various disadvantages, however.

On the one hand, the application of the adhesive to the adhesive surfaces of the rotor blade half shells takes a relatively long time. The adhesive used must therefore have a relatively long pot life to prevent the pot life already expiring before joining the rotor blade half shells. In practice, relatively long cycle times of approx. 24 hours are therefore necessary, whereby approximately 20% of this time is required to cure the adhesive.

On the other hand, the known bonding method described above is characterised by unsatisfactory process reliability, for example because an interruption in application of the adhesive due to a failure of the coating machine requires the complete removal of already applied adhesive in a very short time to prevent the adhesive from curing on the adhesive surfaces.

Further, a laborious reworking of the adhesive areas is necessary in the known bonding method described above, for example levelling it off to smooth a notch.

Finally, in the case of the known bonding method described above, material loss occurs because excess adhesive must always be used as a result of the component tolerances that exist.

Moreover, the so-called injection bonding, where the adhesive is injected into a groove between the assembly parts, is familiar from other technical areas—see DE 10 2004 001 386 B3. The assembly parts involved are a hollow shell and a plug-in element that is plugged into the hollow shell so that the adhesive joint is restricted in a radial direction by the plug-in element on the one hand and by the hollow shell on the other hand. The adhesive surfaces of the plug-in element and hollow shell are therefore not on their end surfaces, so that injection bonding is not suitable for bonding together rotor blade half shells, because in that case the adhesive surfaces are on the end surfaces of the rotor blade half shells. The injection of adhesive into the adhesive joint between the rotor blade half shells would lead to the adhesive escaping from and flowing out of the adhesive joint.

### SUMMARY

This disclosure relates to a bonding method and a corresponding bonding apparatus for bonding together assembly parts, which have adhesive surfaces on the end surfaces thereof to be joined together, particularly for bonding together rotor blade half shells to form a rotor blade for a wind turbine. Accordingly, disclosed herein are improvements to the previously described known bonding method for bonding together rotor blade half shells.

The present disclosure includes the general technical teaching of how to bond rotor blade half shells together by injection bonding, in which an adhesive is injected into the adhesive joint between the adhesive surfaces of the rotor blade half shells. The present disclosure also includes, however, bonding of assembly parts other than rotor blade half shells, where the adhesive surfaces are on the end surfaces of the assembly parts. The injection bonding according to the present disclosure therefore differs from the injection bonding according to DE 10 2004 001 386 B3 by the fact that the adhesive surfaces are found on the end surfaces of the assembly parts to be bonded.

During the bonding method according to the present disclosure, in a first step the assembly parts to be bonded (e.g. rotor blade half shells) may be placed in their final position relative to each other, whereby there is generally not yet any contact between the assembly parts in this final position. An adhesive joint then exists between the assembly parts, into which the adhesive is injected in a next step. Here, the escaping of adhesive from the adhesive joint is prevented as long as the adhesive has not sufficiently cured. The curing of the injected adhesive in the adhesive joint then follows, which produces the adhesive joint between the assembly parts.

As already set out above, when the adhesive is injected into the adhesive joint between the assembly parts, it is necessary to ensure that the adhesive does not run out of the adhesive joint while the adhesive has not yet cured sufficiently. Various possibilities exist within the context of the present disclosure, of which some are described below by way of example.

One possibility for preventing the escape of the adhesive from the adhesive joint is for both assembly parts (e.g. rotor blade half shells) in the area of the adhesive surfaces to have profiles which jointly form an injection channel closed at the sides to accommodate the adhesive when the two assembly parts are in their final position relative to each other. For example, the two assembly parts can together have two material ridges running lengthwise along either side of the adhesive joint which seal the sides of the adhesive joint in the final position of the assembly parts and thereby form the closed injection channel. In one variant, both of these material ridges are applied to the same assembly part. By contrast, in another variant, both assembly parts have a material ridge running lengthwise along the adhesive joint, wherein the two material ridges of the two assembly parts together seal the sides of the adhesive joint, thereby preventing the adhesive escaping from the adhesive joint.

Another possibility for preventing the escape of adhesive from the adhesive joint is for the adhesive joint to be sealed on both sides by a film (e.g. a self-adhesive film), in which the film can simply be adhered to the assembly parts at the side. After the adhesive has cured, the film can then simply be removed again.

By contrast, another possibility for preventing the escape of adhesive from the adhesive joint provides for the adhesive applicator to have sealing elements which seal the adhesive joint in the area of the injection area on both sides to prevent the escape of the adhesive from the adhesive joint. The applicator is moved along the adhesive joint and in the process injects adhesive into the adhesive joint, while the sealing elements moved with the applicator seal the adhesive joint at the injection point across a specific length.

With this option, it must be noted that the adhesive is only cured enough to prevent it escaping from the adhesive joint after a specific curing time. The sealing elements on the applicator only seal the adhesive joint along a specific length, however, wherein the applicator with the sealing elements is moved along the adhesive joint at a certain draw speed. The curing time of the adhesive must therefore be sufficiently short and the draw speed of the applicator sufficiently slow for the adhesive not to escape from the adhesive joint when the sealing elements of the applicator together with the applicator are moved on, leaving the sides of the adhesive joint free.

A substantial advantage of the presently disclosed subject matter is that the cycle time can be greatly reduced by the use of a fast reacting adhesive system with a relatively short pot life and a likewise relatively short curing time. It is therefore possible for the pot life of the adhesive to be substantially shorter than the duration of processing within which the adhesive is applied along the adhesive joint onto the entire assembly part.

With the bonding method according to the present disclosure the assembly parts (e.g. rotor blade half shells) are joined in a certain joining direction, in which the adhesive surfaces of the assembly parts are generally positioned on the end surfaces of the assembly parts and are therefore at right angles to the joining direction. This also constitutes a difference to the previously described known injection bonding of hollow shells and plug-in parts in accordance with DE 10 2004 001 386 B3, because the adhesive surfaces here are arranged parallel to the joining direction of the assembly parts.

The present disclosure is not confined to the above described bonding method, but also comprises corresponding bonding apparatus which results from the above description.

In an embodiment of the bonding apparatus according to the present disclosure, a positioning unit is provided to move the applicator for the adhesive along the adhesive joint. The positioning unit may, for example, involve a carriage with a transport platform on which a robot is placed.

The entire application technology (e.g. dosing pump, valves, storage battery, storage tank, controller etc.) that serves to supply the applicator with the adhesive can also be arranged on the positioning unit. This offers the advantage of short hose lengths between the application technology and the applicator.

Within the framework of the present disclosure, the positioning unit moves the applicator along the adhesive joint to inject the adhesive into the adhesive joint. The movement of the positioning unit can be controlled here by a control unit according to a programmed trajectory. Alternatively, it is also possible, however, to provide a sensor (e.g. optical sensor, tactile sensor or ultrasonic sensor) that detects the path of the adhesive joint, in which the control unit then moves the positioning unit according to the path of the adhesive joint detected by the sensor, so that the applicator of the adhesive joint follows. In another variant, by contrast, a position sensor (e.g. GPS sensor, GPS: Global Positioning System) is provided to detect the position of the applicator, so that the control unit can actuate the positioning unit accordingly.

Various possibilities exist within the context of the present disclosure for supplying the positioning unit with electricity and other media (e.g. compressed air, paint etc.). One possibility provides an energy chain system for wired power supply, which is known from the state of the art and does not therefore require further explanation. Alternatively, the possibility exists for a contactless power supply for the positioning unit, in particular by means of an induction loop, which is similarly known from the state of the art and does not therefore require further explanation. By contrast, in another alternative a storage battery (e.g. battery, fuel cell) is provided on the positioning unit to supply power to the positioning unit.

In a different embodiment, by contrast, the bonding apparatus has a portal to position the applicator which can be pushed along an X-axis, whereby the X-axis is horizontally aligned. A carriage on the portal can be pushed along a horizontal Y-axis here, whereby the Y-axis is aligned at right angles to the X-axis. The actual applicator to inject the adhesive can be pushed on the carriage along a Z-axis, whereby the Z-axis is aligned vertically.

The application technology (e.g. dosing pump, valves, storage battery, storage tank, etc.) here can be arranged on the carriage, i.e., at an extremely short distance to the applicator. This is advantageous because as a result this facilitates a short hose length between the application technology and the applicator.

Other advantageous further developments of the present disclosure are identified in the dependent claims or will be explained in greater detail below with the description of the exemplary embodiments, making reference to the following drawings which show:

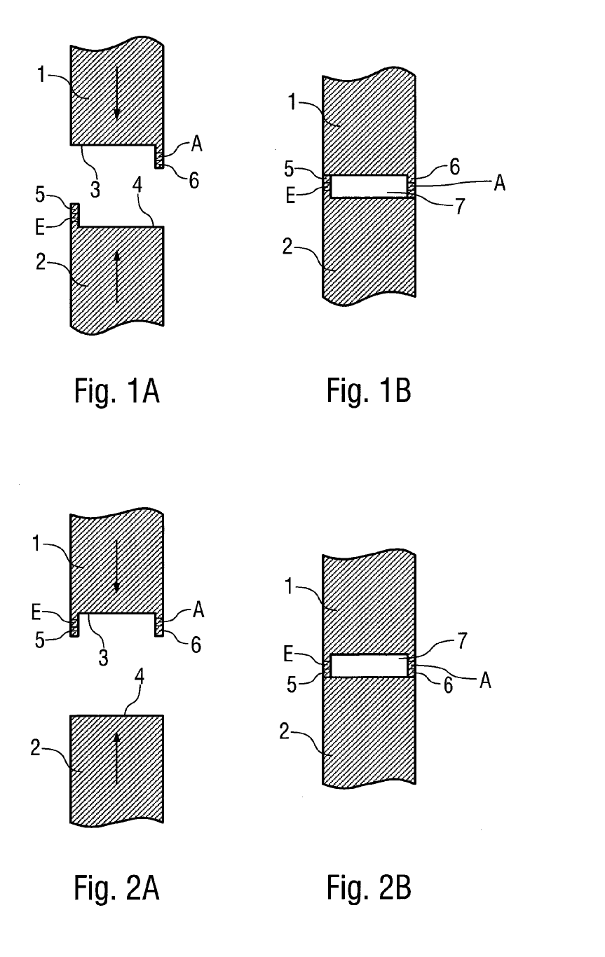

FIG. 1A a cross-sectional view of two assembly parts before joining;

FIG. 1B the assembly parts according to FIG. 1A in assembled state;

FIGS. 2A and 2B modifications of the embodiment according to FIGS. 1A and 1B, wherein the material ridges sealing the injection channel are positioned on the same assembly part;

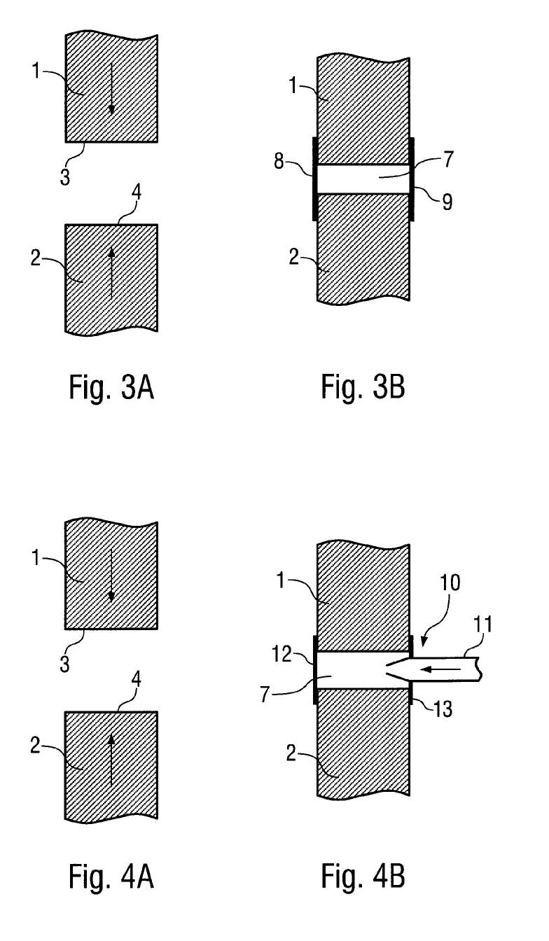

FIGS. 3A and 3B modifications of the above embodiments wherein the sealing of the adhesive joint is achieved using self-adhesive films;

FIGS. 4A and 4B a different modification of the above embodiments wherein the sealing of the adhesive joint is achieved during the injection by the applicator itself;

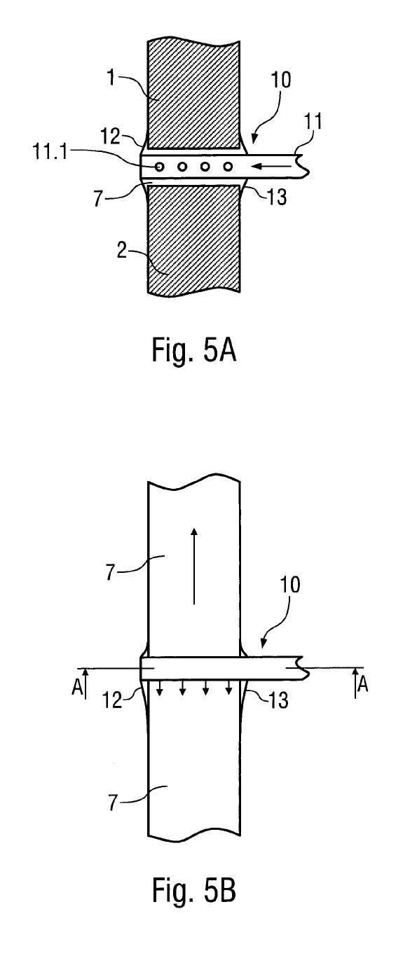

FIG. 5A a cross-sectional view along section A-A in FIG. 5B, wherein the cross-sectional view shows an adhesive joint between two rotor blade half shells;

FIG. 5B a top view along the adhesive joint according to FIG. 5A;

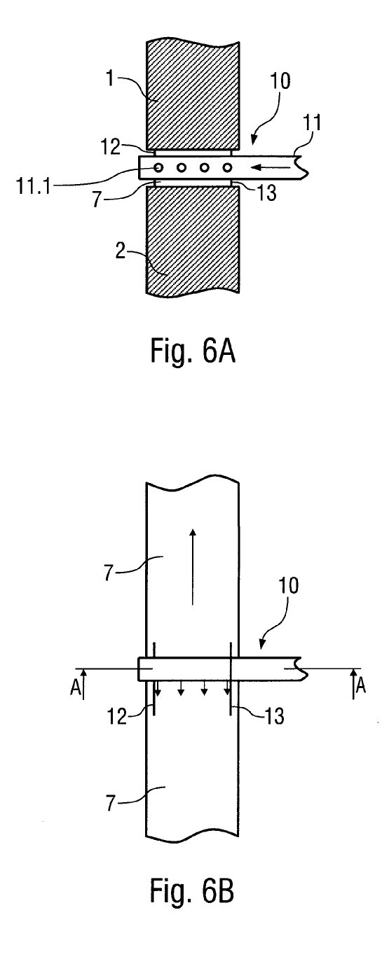

FIG. 6A a cross-sectional view along section A-A in FIG. 6B, wherein the cross-sectional view shows an adhesive joint between two rotor blade half shells;

FIG. 6B a top view along the adhesive joint according to FIG. 6A;

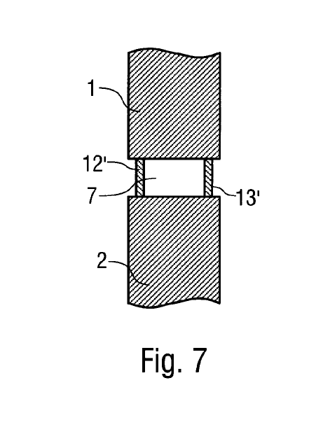

FIG. 7 a cross-sectional view through an adhesive joint with a sealing profile inserted into the adhesive joint to seal the adhesive joint at the side;

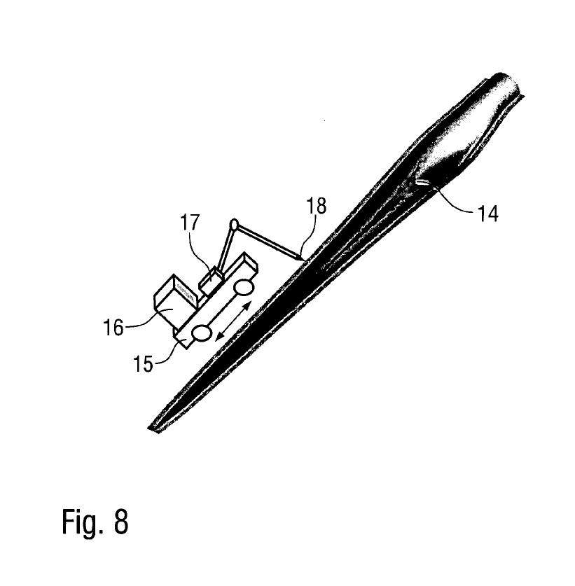

FIG. 8 a schematic presentation of a bonding apparatus according to the present disclosure with a positioning unit to move the applicator along the adhesive joint;

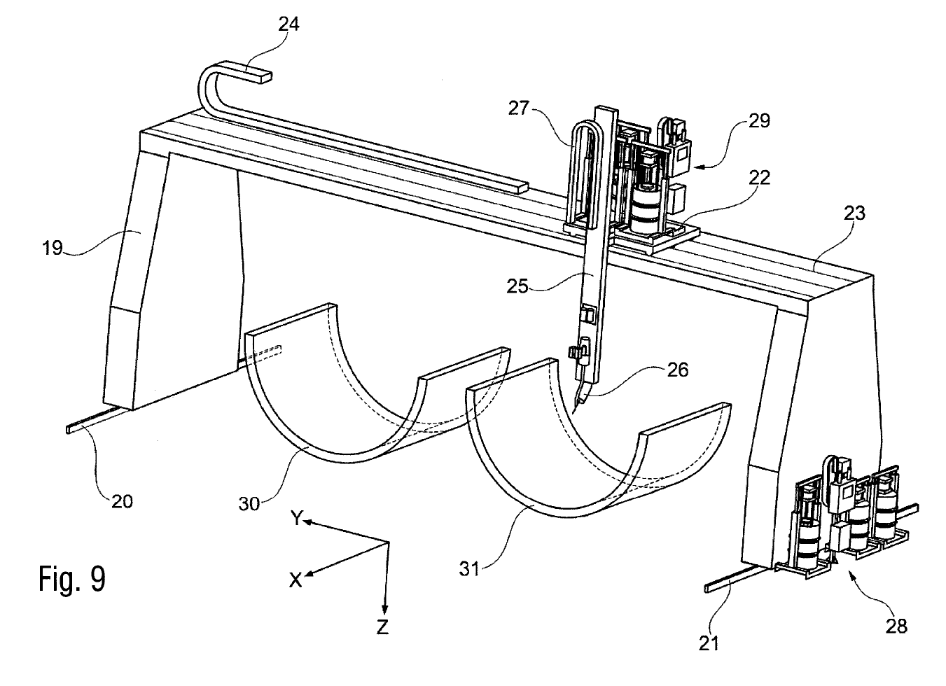

FIG. 9 a perspective view of a bonding apparatus with a sliding portal;

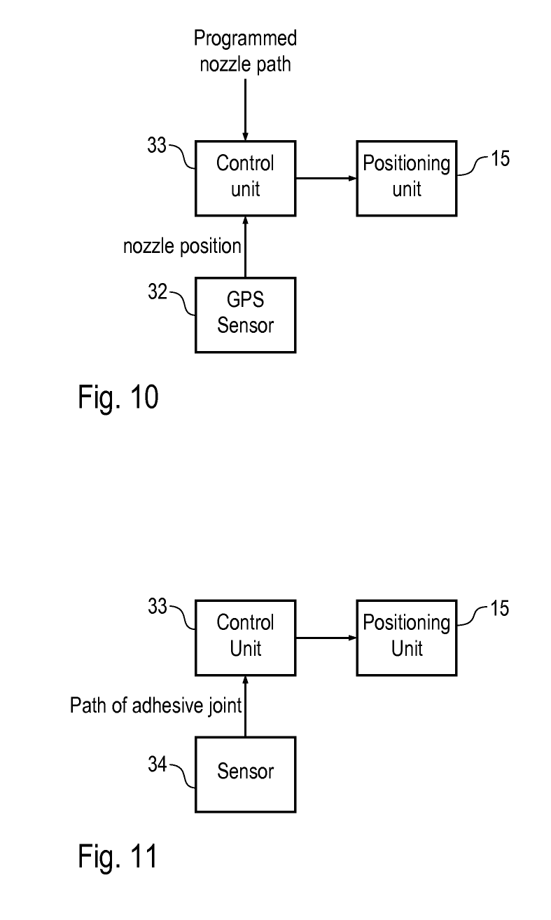

FIG. 10 a schematic presentation of a bonding apparatus according to the present disclosure with a GPS sensor for determining the position of the applicator; and

FIG. 11 a schematic presentation of a bonding apparatus according to the present disclosure with a sensor to detect the path of the adhesive joint.

FIG. 1A shows a cross-sectional view through two assembly parts 1, 2, involving rotor blade half shells which are to be bonded together to make a rotor blade for a wind turbine. FIG. 1A shows the two assembly parts 1, 2 before the actual bonding process, in which the assembly parts 1, 2 are already arranged on top of each other, so that the adhesive surfaces 3, 4 at the end faces of the two assembly parts 1, 2 are facing each other.

In a next step of the bonding method according to the present disclosure, the two assembly parts 1, 2 are then moved towards each other in the direction of the arrow until the shaped material ridges 5, 6 at the side of the assembly parts 1, 2 are lying against the adhesive surface 3, 4 of the facing assembly part 1, 2 as shown in FIG. 1B. In this state, an adhesive joint 7, which is restricted by the two material ridges 5, 6 and by the two adhesive surfaces 3, 4, remains between the two assembly parts 1, 2.

The two material ridges 5, 6 are characterised by an inlet opening E to enable an adhesive to be injected into the adhesive joint 7. Furthermore, the two material ridges 5, 6 have an outlet opening A so that air can escape from the adhesive joint 7 during the injection of the adhesive into the adhesive joint 7. The inlet opening E and the outlet opening A may be positioned at any place along the adhesive joint 7.

During injection of the adhesive into the adhesive joint 7, the material ridges 5, 6 at the side prevent the as yet uncured adhesive from escaping from the adhesive joint 7 during curing.

An advantage of the above described bonding method lies in the reduction of the possible cycle time through use of a fast reacting adhesive system. This is made possible by the fact that the injection of the adhesive into the adhesive joint 7 requires substantially less time than the application of the adhesive onto the adhesive surfaces in the conventional bonding method.

A further advantage of the above described bonding method according to the present disclosure lies in the greater process reliability, because the injection of the adhesive into the adhesive joint 7 is the last process step before surface treatment.

Finally, in the case of the above described bonding method according to the present disclosure, there is no need for the otherwise necessary reworking because no surplus adhesive needs to be leveled off and the adhesive seam is free from notches without reworking.

FIGS. 2A and 2B show a modification of FIGS. 1A and 1B, so that reference is made to the above description to avoid repetition, wherein the same references are used for corresponding details.

A feature of this embodiment is that both material ridges 5, 6 for sealing the sides of the adhesive joint 7 are integrally shaped on the same assembly part 1, whilst in the embodiment according to FIGS. 1A and 1B, one of the two material ridges 5, 6 is integrally shaped respectively on each of the two assembly parts 1, 2.

FIGS. 3A and 3B show a further modification of FIGS. 1A and 1B, so that reference is made to the above description to avoid repetition, wherein the same references are used for corresponding details.

A feature of this embodiment is firstly that there is no need for the material ridges 5, 6 for sealing the sides of the adhesive joint 7.

Instead of this, the sealing of the sides of the adhesive joint 7 during the injection and curing of the adhesive takes place by means of self-adhesive films 8, 9, which are adhered to the adhesive joint 7 or to the adjacent side surfaces of the two assembly parts 1, 2.

In the case of this embodiment, the two assembly parts 1, 2 are therefore firstly fixed in their final position in relation to each other. The self-adhesive films 8, 9 are then affixed. In a further work step, the adhesive is then injected into the adhesive joint 7. The adhesive films 8, 9 may then be removed once the adhesive in the adhesive joint 7 has cured sufficiently to prevent the adhesive escaping from the adhesive joint 7.

As with the material ridges 5, 6 in the above described embodiments, the self-adhesive films 8, 9 are characterised by an inlet opening for injecting the adhesive and an outlet opening to remove the air, whereby inlet opening and outlet opening may be positioned at any place along the adhesive joint 7.

FIGS. 4A and 4B show a further modification of the above described embodiments, so that reference is made to the above description to avoid repetition, wherein the same references are used for corresponding details.

A feature of this embodiment is firstly that again there is no need for the material ridges 5, 6 for sealing the sides of the adhesive joint 7.

Here, the adhesive is injected into the adhesive joint 7 by an applicator, wherein the applicator 10 for application of the adhesive is characterised by a nozzle 11, which is represented only schematically here. Furthermore, the applicator 10 comprises two sealing elements 12, 13, whose purpose is to seal the sides of the adhesive joint 7 during injection of the adhesive until the adhesive has cured sufficiently to prevent it from escaping from the adhesive joint 7.

The two sealing elements 12, 13 here are firmly connected to the applicator 10 and are moved together with the applicator 10 along the adhesive joint 7, i.e., at right angles to the plane of projection.

The two sealing elements 12, 13 here start at the respective injection point at the nozzle 11 and extend along the adhesive joint 7 for a specific length, i.e., the two sealing elements 12, 13 also seal the adhesive joint 7 in a specific area in the direction of movement before and after the nozzle 11. The sealing elements 12, 13 together with the applicator 10 are moved along the adhesive joint 7, so that the adhesive joint 7 is released again after a specific time following an injection process, when the sealing elements 12, 13 have been moved further along the adhesive joint. Therefore, it is important that the draw speed of the applicator 10 and the curing time of the adhesive are co-ordinated such that the injected adhesive does not escape from the adhesive joint 7 when the applicator 10 with the sealing elements 12, 13 continues its movement. The draw speed of the applicator 10 along the adhesive joint 7 must therefore be sufficiently low and the curing time of the adhesive must be sufficiently short to prevent adhesive from escaping from the adhesive joint 7.

FIGS. 5A and 5B show a modification of the above described embodiments, so that reference is made to the above description to avoid repetition, wherein the same references are used for corresponding details.

A feature of this embodiment compared to the embodiment according to FIG. 4B is that the applicator 10 with its nozzle 11 extends over the entire width of the adhesive joint 7. Furthermore, the nozzle 11 is characterised by several nozzle openings 11.1 distributed across the width of the adhesive joint 7, wherein the nozzle openings 11.1 are arranged on the side of nozzle 11 against the direction of movement, as represented by arrows in FIG. 5B.

It can furthermore be seen from FIG. 5B that the side sealing elements 12, 13 in the direction of movement of the applicator 10 have smaller dimensions than those against the direction of movement. This is advantageous to prevent the adhesive escaping from the adhesive joint 7 again behind the applicator 10, despite the movement of the applicator 10 in the direction of the arrow along the adhesive joint 7.

FIGS. 6A and 6B show a modification of the embodiment according to FIGS. 5A and 5B, so that reference is made to the above description to avoid repetition, wherein the same references are used for corresponding details.

A feature of this embodiment is that the sealing elements 12, 13 seal the adhesive joint 7 at the adhesive surfaces 3, 4, i.e., inside the adhesive joint 7, whilst the sealing elements 12, 13 in the embodiment according to FIGS. 5A and 5B seal the adhesive joint 7 outside.

The embodiment according to FIG. 7 largely corresponds to the embodiment according to FIGS. 3A and 3B, so that reference is made to the above description to avoid repetition.

A feature of this embodiment is that a sealing profile is inserted in the adhesive joint 7 which is characterised by two sealing elements 12′, 13′ to seal the sides of the adhesive joint 7.

FIG. 8 shows a schematic presentation of a bonding apparatus for bonding together rotor blade half shells 14 according to the present disclosure, wherein for reasons of simplification only one rotor blade half shell 14 is illustrated.

The bonding apparatus firstly comprises a positioning unit 15, which can be moved in the direction of the double arrow along the adhesive surfaces of the rotor blade half shell 14.

Among other things, the application technology 16 with material feed and controller are found on the positioning unit 15.

Also placed on the positioning unit 15 are a multiple axis robot 17, which is only shown schematically, and a nozzle 18 for application of the adhesive.

The positioning unit 15 is moved by a control unit here (not shown) so that the nozzle 18 follows a programmed (“learned”) trajectory. For this, a GPS sensor (GPS: Global Positioning System) may be provided which determines the spatial position of the positioning unit 15 and the nozzle 18 and actuates the positioning unit 15 and the robot 17 so that the nozzle 18 follows the specified trajectory.

Alternatively, the possibility exists for movement of the nozzle 18 and the positioning unit 15 to be sensor-guided, wherein an optical or tactile sensor determines the path of the adhesive joint on the rotor blade half shell 14 and the nozzle 18 tracks the adhesive joint.

The power supply to the positioning unit 15 may be via a conventional energy chain system or may be contactless, for example by means of induction loops. Alternatively or additionally, it is possible to supply power by means of an energy storage device on the positioning unit 15, wherein the energy storage device may, for example, comprise a battery or a fuel cell.

FIG. 9 shows a perspective view of a further embodiment of bonding apparatus according to the present disclosure with a portal 19, wherein the portal 19 can be moved on two rails 20, 21 in the X-direction, i.e., in a horizontal direction. A carriage 22 on the portal 19 can be moved in a Y-direction on rails 23, i.e., in a horizontal direction at right angles to rails 20, 21.

An energy chain 24 is provided to supply the carriage 22 with electricity and other media, which is only shown here schematically.

An applicator 25 is attached to the carriage 22 and can be moved in the Z-direction, i.e., in a vertical direction, wherein the applicator guides a nozzle 26 for application of the adhesive and is supplied with electricity and other media by an energy chain 27.

The application technology 28 (e.g. controller, valves, pumps etc.) is positioned on the side of the portal 19, wherein the application technology 28 can be moved with the portal 19.

Furthermore, application technology 29 is positioned on the carriage 22, and is used to move the carriage 22. The arrangement of the application technology 29 on the carriage 22 offers the advantage of short distance between the application technology 29 and the nozzle 26. In turn, this leads advantageously to a low pressure loss in the pipes, a rapid temporal response and low flushing losses due to the short pipe length between the application technology 29 and the nozzle 26.

The illustrated bonding apparatus can, for example, be used to join two rotor blade half shells 30, 31 together.

FIG. 10 shows a schematic presentation of controlling the movement of the positioning unit 15 and the nozzle 18 in an embodiment according to FIG. 8.

In the embodiment according to FIG. 10, the spatial position of the nozzle 18 is detected by a GPS sensor 32 and transmitted to a control unit 33, which actuates the positioning unit 15 and the robot 17 situated on it such that the nozzle 18 follows a programmed nozzle track.

The embodiment according to FIG. 11 partially corresponds to the embodiment according to FIG. 10, so that reference is made to the above description to avoid repetition, wherein the same references are used for corresponding details.

A feature of this embodiment is that a sensor 34 is provided to detect the path of the adhesive joint and to send it to the control unit 33, wherein the control unit 33 actuates the positioning unit 15 so that the nozzle 18 follows the determined path of the adhesive joint.

The sensor 34 may, for example, involve an optical sensor, a tactile sensor or an ultrasonic sensor, to name but a few possibilities.

The claimed invention is not limited to the above described preferred embodiments. Rather a number of variations and modifications are possible and which likewise make use of the invention concept and therefore fall within the scope of protection.

1-20. (canceled)

21. A method of bonding together assembly parts that have adhesive surfaces on end surfaces, wherein respective end surfaces of the assembly parts are to be joined together, the method comprising bonding the assembly parts to one another by injection bonding in which an adhesive is injected into an adhesive joint between the adhesive surfaces of the assembly parts.

22. The method of claim 21, further comprising:
positioning the assembly parts to be joined together in their final position relative to each other, so that the adhesive joint is created between the assembly parts;
injecting the adhesive into the adhesive joint;
preventing an escape of the adhesive from the adhesive joint; and
curing of the adhesive in the adhesive joint.

23. The method of claim 22, wherein:
both assembly parts have profiles in an area of the adhesive surfaces, the parts jointly forming an injection channel closed at sides to accommodate the adhesive when the two assembly parts are in a final position; and
the assembly parts jointly have two material ridges that run lengthwise along the adhesive joint on both sides of the adhesive joint and that seal sides of the adhesive joint in the final position of the assembly parts and thereby preventing escape of the adhesive from the adhesive joint.

24. The method of claim 23, wherein:
the two assembly parts each have one material ridge running lengthwise along the adhesive joint on an opposite side of the adhesive joint, wherein the two material ridges seal the sides of the adhesive joint in the final position of the assembly parts thereby preventing the escape of the adhesive from the adhesive joint.

25. The method of claim 23, wherein at least one of the material ridges has at least one inlet opening and at least one outlet opening.

26. The method of claim 22, wherein the adhesive joint is sealed on both sides by the application of a film to prevent the escape of the adhesive from the adhesive joint.

27. The method of claim 26, wherein the film is self-adhesive.

28. The method of claim 26, wherein the film has at least one inlet opening and at least one outlet opening.

29. The method of claim 22, wherein:
the adhesive is injected into the adhesive joint using an applicator;
the applicator comprises sealing elements which seal the adhesive joint on both sides in the area of the injection point to prevent the escape of the adhesive from the adhesive joint; and
the applicator is moved along the adhesive joint with the sealing elements during injection of the adhesive.

30. The method of claim 29, wherein:
the adhesive has a specified curing time;
the applicator is moved along the adhesive joint at a specific draw speed;
the sealing elements of the applicator seal the adhesive joint over a specific length;
the curing time of the adhesive is so short and the draw speed of the applicator so slow that the adhesive does not escape from the adhesive joint when the sealing elements of the applicator release the sides of the adhesive joint.

31. The method of claim 21, wherein:
the adhesive has a specified pot time within which the adhesive can be processed;
the adhesive is injected into the adhesive joint for a specified processing duration; and
the pot time is less than the processing duration.

32. The method of claim 21, wherein:
the assembly parts are joined in a specific joining direction; and
the adhesive surfaces of the assembly parts are aligned at right angles to the joining direction.

33. The method of claim 21, wherein the assembly parts are rotor blade half shells that are bonded together to form a rotor blade for a wind turbine.

34. A bonding apparatus for bonding together assembly parts that have adhesive surfaces on end surfaces, wherein respective end surfaces of the assembly parts are to be joined together, wherein the bonding apparatus bonds the assembly parts together by injection bonding, and wherein the bonding apparatus injects an adhesive into an adhesive joint between the adhesive surfaces of the assembly parts.

35. The bonding apparatus of claim 34, wherein:
both assembly parts have profiles in an area of the adhesive surfaces, the parts jointly forming an injection channel closed at the sides to accommodate the adhesive when the two assembly parts are in their final position; and
the assembly parts jointly have two material ridges that run lengthwise along the adhesive joint on both sides of the adhesive joint and that seal sides of the adhesive joint in the final position of the assembly parts and thereby preventing escape of the adhesive from the adhesive joint.

36. The bonding apparatus of claim 35, wherein:
the two assembly parts each have one material ridge running lengthwise along the adhesive joint on an opposite side of the adhesive joint, wherein the two material ridges seal the sides of the adhesive joint in the final position of the assembly parts thereby preventing the escape of the adhesive from the adhesive joint.

37. The bonding apparatus of claim 35, wherein at least one of the material ridges has at least one inlet and at least one outlet.

38. The bonding apparatus of claim 35, wherein the adhesive joint is sealed on both sides by the application of a film thereby preventing the escape of the adhesive from the adhesive joint.

39. The bonding apparatus of claim 38, wherein the film is self-adhesive.

40. The bonding apparatus of claim 38, wherein the film has at least one inlet opening and at least one outlet opening.

41. The bonding apparatus of claim 34, further comprising:
an applicator arranged to inject the adhesive into the adhesive joint between the adhesive surfaces of the assembly parts;
a positioning unit to move the applicator along the adhesive joint; and
sealing elements positioned on the applicator and moved with the applicator along the adhesive joint, wherein the sealing elements seal the adhesive joint on both sides thereby preventing the escape of the adhesive from the adhesive joint.

42. The bonding apparatus of claim 34, wherein:
application technology is also placed on the positioning unit, which supplies the applicator with the adhesive;
the application technology placed on the positioning unit having at least one of the following components:
a dosing pump for metering the adhesive;
a valve to control the supply of adhesive;
an energy storage device; and
a storage tank for the adhesive.

43. The bonding apparatus of claim 41, further comprising a control unit that controls the movement of the positioning unit along the adhesive joint.

44. The bonding apparatus of claim 43, wherein the control unit moves the positioning unit such that the applicator follows a programmed movement path.

45. The bonding apparatus of claim 44, wherein:
a sensor is provided to detect the path of the adhesive joint; and
the control unit moves the positioning unit according to the path of the adhesive joint detected by the sensor.

46. The bonding apparatus of claim 44, wherein:
a position sensor is provided that detects the position of the applicator; and
the control unit moves the positioning unit according to the position of the applicator recorded by the position sensor such that the applicator follows a programmed movement path.

47. The bonding apparatus of claim 41, further comprising at least one of:
an energy chain system for wired power supply to the positioning unit;
a contactless power supply for the positioning unit; and
an energy storage device on the positioning unit

48. The bonding apparatus of claim 44, further comprising:
a portal that can be moved along an X-axis;
a carriage which can be moved on the portal along a Y-axis, wherein the Y-axis is aligned at right angles to the X-axis; and
an applicator to inject the adhesive, wherein the applicator can be moved on the carriage along a Z-axis, wherein the Z-axis is aligned at right angles to the X-axis and to the Y-axis.

49. The bonding apparatus of claim 48, wherein:
application technology is also arranged on the carriage which supplies the applicator with the adhesive; and
the application technology arranged on the carriage is comprises at least one of:
a dosing pump for metering the adhesive;
a valve to control the supply of adhesive;
an energy storage device; and
a storage tank for the adhesive.
